(19) United States
(12) Patent Application Publication
(10) Pub. No.: US 2019/0001453 A1
(43) Pub. Date: Jan. 3, 2019

(54) MACHINE TOOL

(71) Applicant: OKUMA CORPORATION, Niwa-Gun (JP)

(72) Inventor: Masanori ISHIKAWA, Niwa-Gun (JP)

(73) Assignee: OKUMA CORPORATION, Niwa-Gun (JP)

(21) Appl. No.: 15/964,319

(22) Filed: Apr. 27, 2018

(30) Foreign Application Priority Data
Jun. 29, 2017 (JP) 2017-127881

(51) Int. Cl. B23Q 11/08; B23Q 3/155

(52) U.S. Cl. CPC B23Q 11/0883; B23Q 5/341; B23Q 3/15534; B23Q 3/15553

(57) ABSTRACT

A machine tool includes a shielding cover, a door, and an automatic tool changer. The shielding cover covers a machining space of a main spindle. The door opens and closes an opening disposed in the shielding cover. The automatic tool changer automatically exchanges a tool to be mounted to the main spindle. The automatic tool changer exchanges the tool to be mounted to the main spindle by turning an arm in a plane perpendicular to the main spindle so as to cause the arm to enter into and exit from the machining space. The arm is configured to grip and release the tool. The turning of the arm is synchronized with the opening and closing movement of the door.

### BACKGROUND

This application claims the benefit of Japanese Patent Application Number 2017-127881 filed on Jun. 29, 2017, the entirety of which is incorporated by reference.

### TECHNICAL FIELD

The disclosure relates to a machine tool that includes an automatic tool changer configured to automatically exchange a tool to be mounted to a main spindle.

### RELATED ART

A common machine tool such as a machining center includes a shielding cover so as to cover a main spindle and a material to be machined (a workpiece) for preventing scattering of cutting wastes and cutting fluids generated while the workpiece is machined by the main spindle. A recent machine tool includes an automatic tool changer (ATC) for automatically exchanging a tool to be mounted on a main spindle. Then, as a machine tool that includes such an ATC, as disclosed in Japanese Unexamined Patent Application Publication No. 8-318443 (JP-A-8-318443), there has been known a machine tool in which a shielding cover includes an opening and a door that opens and closes the opening, the door slides back and forth to open the opening, and an arm configured to grip and release a tool is rotated around a front-rear axis and entered into a machining area from the opened opening, thus exchanging a tool on a main spindle.

The above-described machine tool is required not only to ensure cutting the workpiece in a short period but also to shorten a non-cutting period such as an automatic exchange of the tool and an exchange of the workpiece after the machining. However, since the machine tool as disclosed in JP-A-8-318443 has a moving direction of the arm perpendicular to a moving direction of the door of the shielding cover, the arm on which the tool is mounted cannot be rotated until the shielding cover almost completes the opening and closing movement. In addition, since some tools are long, it is difficult to design the door of the shielding cover so as to have a short slide distance. Therefore, the above-described machine tool as disclosed in JP-A-8-318443 has had a difficulty in performing the automatic exchange of the tool in a short period.

It is an object of the disclosure to provide a machine tool having good machining efficiency configured to perform an automatic exchange of a tool in a short period.

### SUMMARY

In order to achieve the above-described object, there is provided a machine tool according to a first aspect of the disclosure. The machine tool includes a shielding cover, a door, and an automatic tool changer. The shielding cover covers a machining space of a main spindle. The door opens and closes an opening disposed in the shielding cover. The automatic tool changer automatically exchanges a tool to be mounted to the main spindle. The automatic tool changer exchanges the tool to be mounted to the main spindle by turning an arm in a plane perpendicular to the main spindle so as to cause the arm to enter into and exit from the machining space. The arm is configured to grip and release the tool. The turning of the arm is synchronized with opening and closing movement of the door.

According to a second aspect of the disclosure, in the first aspect of the disclosure, a turning direction of the arm when the arm approaches the main spindle and a moving direction of the door when the door is opened through the machining space may be both upward directions.

In the machine tool according to the first aspect, since the turning of the arm of the automatic tool changer is synchronized with the opening and closing movement of the door of the shielding cover, an operation by the automatic tool changer and the opening and closing movement of the door can be simultaneously progressed. Therefore, a period necessary for the tool exchange can be shortened, thus providing excellent machining efficiency.

In the machine tool according to the second aspect, since the turning direction of the arm when the arm approaches the main spindle and the moving direction of the door when the door is opened through the machining space are both upward directions, a waste of a slide distance of the door applicable to a long tool can be eliminated to much shorten a non-cutting period, thus providing extremely excellent machining efficiency.

### BRIEF DESCRIPTION OF THE DRAWINGS

FIG. 1 is an explanatory view (a perspective view) illustrating a machine tool.

FIGS. 2A to 2C are explanatory views (front views) illustrating an operation of an arm of an automatic tool changer and a door of a shielding cover.

### DETAILED DESCRIPTION

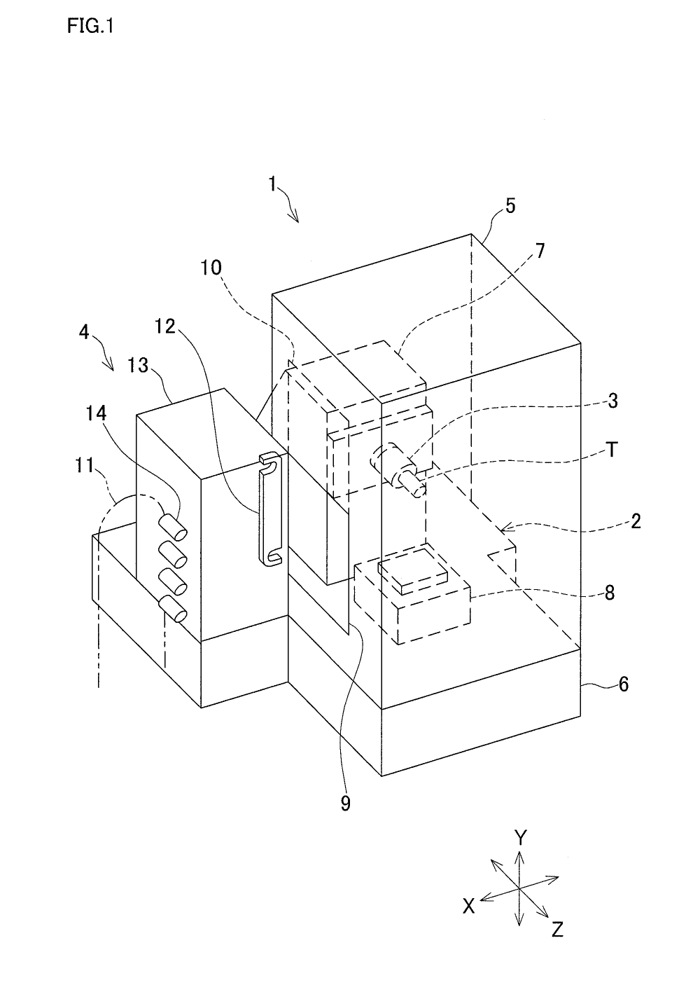

The following describes one embodiment of a machine tool according to the disclosure in detail based on the drawings. FIG. 1 illustrates an exemplary machine tool according to the disclosure. A machine tool (a horizontal machining center) 1 includes a machine main body 2 that has a main spindle 3 to which a tool T is mountable, an automatic tool changer (hereinafter referred to as an ATC) 4 that automatically exchanges the tool T, a shielding cover 5 that shields the machine main body 2 for preventing scattering of cutting wastes and cutting fluids at machining by the main spindle 3, a control unit (not illustrated) that controls contents of the machining of a material to be machined (a workpiece) by the main spindle 3, and the like. In the following description, as indicated in FIG. 1, a lateral direction is defined as an X-axis direction, a vertical direction is defined as a Y-axis direction, and a front-rear direction is defined as a Z-axis direction.

The machine main body 2 includes a bed 6 as a base, a main spindle head 7 configured to move the main spindle 3 along each of the X-axis direction and the Y-axis direction, a table 8 on which the workpiece is placed, and the like. The table 8 is movable along the Z-axis direction and configured to cause the workpiece on the table 8 to approach the main spindle 3.

The shielding cover 5 is made of a metal plate, and formed in a rectangular parallelepiped shape so as to cover a front part (namely, a machining space of the main spindle 3) of the machine main body 2. Then, on a side where the ATC 4 is installed, a rectangular-shaped opening (a window) 9 is disposed to allow the tool T to be mounted to the main spindle 3 to be automatically exchanged. The opening 9 includes a door (a shutter) 10 made of a metal plate and the like and configured to move up and down.

On the other hand, the ATC 4 includes a tool magazine 11, an exchanging arm 12, a cam box 13, and the like. The tool magazine 11 is a unit to which multiple tools T are mountable. The exchanging arm 12 is configured to exchange the tool T between the main spindle 3 and the tool magazine 11. The cam box 13 includes a plurality of remote cylinders (not illustrated) and a plurality of cams for exchanging the tool T by the exchanging arm 12 and moving the door 10 up and down.

The exchanging arm 12 is formed in a long flat plate shape, and has both ends including cutouts such that the tools are removably attachable to the cutouts (the drawing omits an illustration of a mechanism for mounting and removing the tools). Then, the exchanging arm 12 is configured to exchange the tool T between the main spindle 3 and the tool magazine 11 by turning in a vertical plane parallel to a front surface of the machine main body 2 around a rotation shaft (not illustrated) disposed on a back surface at the center in a longitudinal direction and moving in a horizontal direction (the Z-axis direction).

The tool magazine 11 is configured to circularly move a plurality of holders 14, to which the tools T are mountable, in a constant elliptical shape, in the vertical plane parallel to the front surface of the machine main body 2. The control unit is configured to cause the tool magazine 11 to position a predetermined tool T at a position where the exchanging arm 12 can grip the tool T.

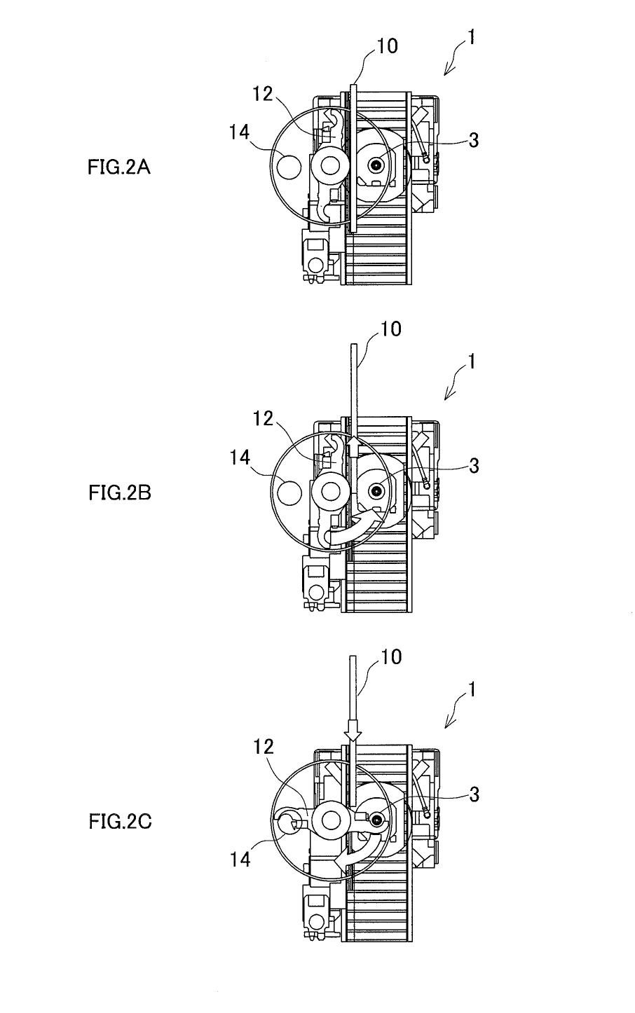

The following describes an operation in a case where the ATC 4 automatically exchanges the tool T in the above-described machine tool 1. The automatic exchange of the tool T by the ATC 4 in the machine tool 1 is controlled by the control unit (not illustrated). FIGS. 2A to 2C illustrate the state the ATC 4 automatically exchanges the tool, and when cutting is performed with the tool T (T₁) on the main spindle 3, the door 10 is in a state of being closed (a state of being positioned at a lower side to shield the opening 9) and the exchanging arm 12 is in a state of waiting in a posture having the longitudinal direction parallel to a plate surface of the door 10 (see FIG. 2A).

Then, when the cutting with the tool T₁ on the main spindle 3 is terminated and the mounted tool T₁ is exchanged, the door 10 of the shielding cover 5 moves up to open the opening 9. Simultaneously with the moving up of the door 10, the exchanging arm 12 rotates to a predetermined direction (a counterclockwise rotation) by about 90 degrees, and grips the tool T₁ on the main spindle 3 by one cutout while simultaneously gripping a tool T₂ on the tool magazine 11 (see FIG. 2B). At this time, the exchanging arm 12 starts the rotation at timing identical to the timing of the start of upward movement of the door 10.

After the exchanging arm 12 thus grips the tool T₁ on the main spindle 3 and the tool T₂ on the tool magazine 11 on both ends, while further rotates to the predetermined direction (the counterclockwise rotation) by about 180 degrees, the exchanging arm 12 moves forward and backward in the horizontal direction (the Z-axis direction) to mount the tool T₂ gripped on the one cutout to the main spindle 3 and simultaneously mounts the tool T₁ gripped on the other cutout to the holder 14 of the tool magazine 11.

After the tools T₁ and T₂ are exchanged between the main spindle 3 and the tool magazine 11 as described above, the exchanging arm 12 rotates in a direction (clockwise) reverse to the rotation direction at the tool exchange by about 90 degrees, and returns to the state of waiting in the posture having the longitudinal direction parallel to the plate surface of the door 10. Furthermore, simultaneously with the turning of the exchanging arm 12, the door 10 of the shielding cover 5 moves down to close the opening 9 (see FIG. 2C). At this time, the door 10 starts the moving down at timing identical to the timing of the start of the rotating movement of the exchanging arm 12.

The machine tool 1 includes the shielding cover 5 that covers a machining space of the main spindle 3, the door 10 that opens and closes the opening 9 disposed in the shielding cover 5, and the ATC 4 that automatically exchanges the tool T to be mounted to the main spindle 3. Then, as described above, the machine tool 1 is configured to exchange the tool T to be mounted to the main spindle 3 such that the ATC 4 turns the exchanging arm 12 configured to grip and release the tool T in the plane perpendicular to the main spindle 3 so as to cause the exchanging arm 12 to enter into and exit from the machining space. Further, the machine tool 1 is configured to shorten a period necessary for the tool exchange such that the turning of the exchanging arm 12 is synchronized with the opening and closing movement of the door 10 so as to simultaneously progress the operation by the ATC 4 and the opening and closing movement of the door 10. Accordingly, machining efficiency is excellent.

In the machine tool 1, the turning direction of the exchanging arm 12 on approaching the main spindle 3 and the moving direction of the door 10 on opening the machining space are both upward directions. Then, a waste of a slide distance of the door 10 applicable to a long tool can be eliminated to much shorten a non-cutting period, thus providing extremely excellent machining efficiency.

The configuration of the machine tool according to the disclosure is not limited to the aspect of the above described embodiment, and the configurations of the shape, the structure, and similar element of the machine main body, the main spindle, the ATC, the shielding cover, the door, the tool magazine, the exchanging arm, and the like can be modified as necessary without departing from the spirit of the disclosure. For example, the tool magazine of the ATC is not limited to a tool magazine in which a plurality of holders to which the tools are mountable are configured to circularly move in a constant elliptical shape in a vertical plane parallel to a front surface of a machine main body, but a tool magazine in which a plurality of holders are configured to circularly move in a constant circle or elliptical shape in a vertical plane parallel to a front-rear direction and a similar tool magazine may be employed. The table on which the workpiece is placed is not limited to a table secured to the bed as the above-described embodiment, but a table disposed to be rotatable around a rotation shaft along the X-axis direction and a similar table may be employed.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A machine tool comprising:
a shielding cover that covers a machining space of a main spindle;
a door that opens and closes an opening disposed in the shielding cover; and
an automatic tool changer that automatically exchanges a tool to be mounted to the main spindle, wherein
the automatic tool changer exchanges the tool to be mounted to the main spindle by turning an arm in a plane perpendicular to the main spindle so as to cause the arm to enter into and exit from the machining space, the arm being configured to grip and release the tool, and
the turning of the arm is synchronized with opening and closing movement of the door.

2. The machine tool according to claim 1, wherein
a turning direction of the arm when the arm approaches the main spindle and a moving direction of the door when the door is opened through the machining space are both upward directions.
